(19) United States
(12) Patent Application Publication
(10) Pub. No.: US 2009/0209280 A1
(43) Pub. Date: Aug. 20, 2009

(54) WIRELESS NETWORK CONTROLLER AND WIRELESS COMMUNICATION SYSTEM

(75) Inventors: Wataru Kawaguchi, Fukuoka (JP); Kazuya Nishimura, Fukuoka (JP); Yasushi Yano, Fukuoka (JP); Koki Shigaki, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/328,542

(22) Filed: Dec. 4, 2008

(30) Foreign Application Priority Data
Dec. 5, 2007 (JP) 2007-314958

(51) Int. Cl. H04B 7/00; H04W 36/00

(52) U.S. Cl. 455/525; 455/436

(57) ABSTRACT

A wireless network controller according to an embodiment includes multiple base stations, having multiple wireless channels including wireless channels having different communication rates, for carrying out wireless communication with communication terminals using the wireless channels. The wireless network controller controls a base station communicating with the communication terminal before movement and a movement destination base station for a new communication when the communication terminal is required to communicate with another base station. The wireless network controller further comprises a traffic amount confirmation section for confirming the traffic amount of the communication performed between the communication terminal and the base station that was used before movement and a communication request section for obtaining the communication rate corresponding to the traffic amount confirmed using the traffic amount confirmation section, and for requesting communication with the movement destination base station using a wireless channel having the communication rate.

### CROSS-REFERENCE TO RELATED APPLICATIONS

This application is based upon and claims the benefit of priority of the prior Japanese Patent Application No. 2007-314958, filed on Dec. 5, 2007, the entire contents of which are incorporated herein by reference.

### TECHNICAL FIELD

A wireless network controller controls multiple base stations. A wireless communication system has such a wireless network controller.

A wireless network has multiple base stations. The wireless network has a wireless network controller. Communication terminals (mobile communication terminals) that are mobile and represented by portable telephones, etc. can perform communication via the wireless network. Communication between mobile communication terminals or communication between a mobile communication terminal and a server, etc. connected to the Internet is an example of communication via the wireless network. A mobile communication terminal performs wireless communication with the nearest base station. Furthermore, a mobile communication terminal also performs communication with another mobile communication terminal, a server, etc. connected to the Internet via a base station.

A wireless channel is used for the wireless communication between the base station and the mobile communication terminal. The wireless channels are available in multiple quantities. The multiple wireless channels include wireless channels having different communication rates. Each base station has multiple wireless channels that can be used for communication. During communication, one of the multiple wireless channels is used. One of the wireless channels is assigned to a mobile communication terminal that is attempting to communicate with a base station. This assignment of the wireless channel is carried out using a wireless network controller. The wireless network controller is connected to multiple base stations. The wireless network has the wireless network controller and multiple base stations. The wireless network controller controls the multiple base stations. The control carried out by the wireless network controller includes the assignment of wireless channels. A wireless communication system has a mobile communication terminal, multiple base stations and a wireless network controller as described above. The wireless communication system is widely used.

Wireless communication using a wireless channel will be described below. Wireless communication may take a long time when the traffic amount is excessively large in comparison to the communication rate of the wireless channel. In such a case, the wireless channel is occupied with data at all times and is used constantly. On the other hand, the traffic amount may be excessively small in comparison to the communication rate of the wireless channel. In this case, wireless communication is completed in a short time, and the wireless channel is occupied with very little data and is in an idle state much of the time. Hence, the wireless network controller assigns a wireless channel with a communication rate corresponding to the traffic amount.

However, generally speaking, the traffic amount of wireless communication is not constant. The traffic amount changes depending on the state of wireless communication.

Japanese Patent Application Laid-Open Publication No. 2005-73087 has proposed a technology in which during communication between a mobile communication terminal and a base station, a wireless network controller confirms the traffic amount of the wireless communication and carries out wireless channel switching depending on the change in the traffic amount. In this technology, the wireless network controller periodically carries out traffic amount confirmation and wireless channel switching (rate control) at given time intervals. As a result, the wireless communication between the mobile communication terminal and the base station is performed using a wireless channel having an optimum communication rate corresponding to the traffic amount, and thus the wireless communication resources are utilized effectively.

Japanese Patent Application Laid-Open Publication No. 2003-284116 has proposed a technology in which when a handover request is transmitted from a mobile communication terminal, the wireless channel of the base station having been used before switching is first switched before handover to a wireless channel having the same communication rate as the communication rate of a wireless channel available in a switching destination base station, and then handover is carried out.

In both the technologies described in the above-mentioned documents, handover cannot be carried out if wireless channels having a communication rate common to two base stations between which wireless communication of a mobile communication terminal is switched are not available.

### SUMMARY

A wireless network controller according to the present embodiment includes multiple base stations, having multiple wireless channels that include wireless channels having different communication rates for carrying out wireless communication with communication terminals using the wireless channels. The wireless network controller controls a base station communicating with the communication terminal before movement and a base station for new communication with the communication terminal after movement in the case that the communication terminal is required to communicate with another base station. The wireless network controller includes a traffic amount confirmation section for confirming the traffic amount of the communication performed between the communication terminal and the base station used before movement, and a communication request section for obtaining a communication rate corresponding to the traffic amount confirmed using the traffic amount confirmation section and for requesting communication with the base station for communication after movement using a wireless channel having a desired communication rate.

Additional objects and advantages of the embodiment will be set forth in part in the description which follows, and in part will illustrated in the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic view illustrating how handover is carried out according to a first embodiment;

FIG. 2 is a block diagram illustrating the details of a wireless network controller 100;

FIG. 3 is a view illustrating the handover processing sequence of the wireless network controller;

FIG. 4 is a view conceptually illustrating handover and communication rate;

FIG. 5 is a schematic view illustrating how handover is carried out according to a second embodiment;

FIG. 6 is a block diagram illustrating two wireless network controllers;

FIG. 7 is a view illustrating the handover processing sequence of the wireless network controller;

FIG. 8 is a view conceptually illustrating handover and communication rate;

FIG. 9 is a view illustrating how handover is carried out according to comparison example 1;

FIG. 10 is a block diagram illustrating a wireless network controller 500 according to comparison example 1;

FIG. 11 is a view conceptually illustrating rate control according to comparison example 1;

FIG. 12 is a view illustrating the processing sequence of the wireless network controller 500 according to comparison example 1;

FIG. 13 is a view conceptually illustrating handover and communication rate according to comparison example 1; and

FIG. 14 is a view conceptually illustrating a state in which repetition time intervals are shortened in the rate control that is repeated periodically according to comparison example 2.

### DETAILED DESCRIPTION OF THE EMBODIMENTS

Embodiments will be described below referring to the drawings.

First, a first embodiment will be described.

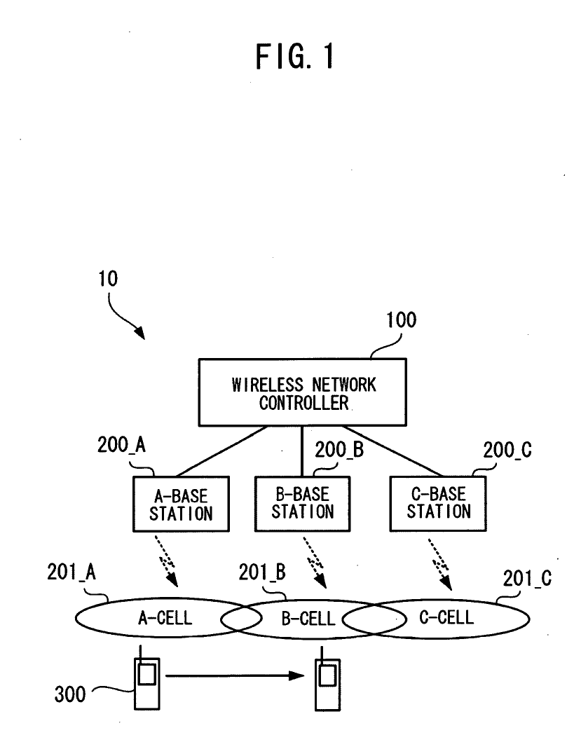

FIG. 1 is a schematic view illustrating an example of a wireless communication system to which the first embodiment has been applied and also illustrating how handover is carried out.

A wireless communication system 10 is illustrated in FIG. 1. The wireless communication system 10 includes base stations, a wireless network controller and a mobile communication terminal. The base stations include three base stations: an A-base station 200_A, a B-base station 200_B and a C-base station 200_C. The wireless network controller 100 controls these three base stations. A mobile communication terminal 300 performs wireless communication with each base station. The wireless network controller 100 controls numerous base stations other than the three base stations illustrated in the figure. The wireless communication system 10 has numerous wireless network controllers. In FIG. 1, the one wireless network controller 100 and the three base stations described above are illustrated as representatives for the sake of simplicity of illustration.

The A-base station 200_A performs wireless communication with the mobile communication terminal located inside an A-cell 201_A. The B-base station 200_B performs wireless communication with the mobile communication terminal located inside a B-cell 201_B. The C-base station 200_C performs wireless communication with the mobile communication terminal located inside a C-cell 201_C.

The wireless communication system 10 illustrated in FIG. 1 corresponds to an embodiment of the wireless communication system. The wireless network controller 100 corresponds to an embodiment of the wireless network controller. In addition, the A-base station 200_A, the B-base station 200_B_and the C-base station 200_C respectively correspond to an example of the base station referred to in this embodiment. The network comprising multiple base stations, which include these three base stations, and multiple wireless network controllers corresponds to an example of a wireless network referred to in this embodiment. Furthermore, the mobile communication terminal 300 corresponds to an example of a communication terminal referred to in this embodiment.

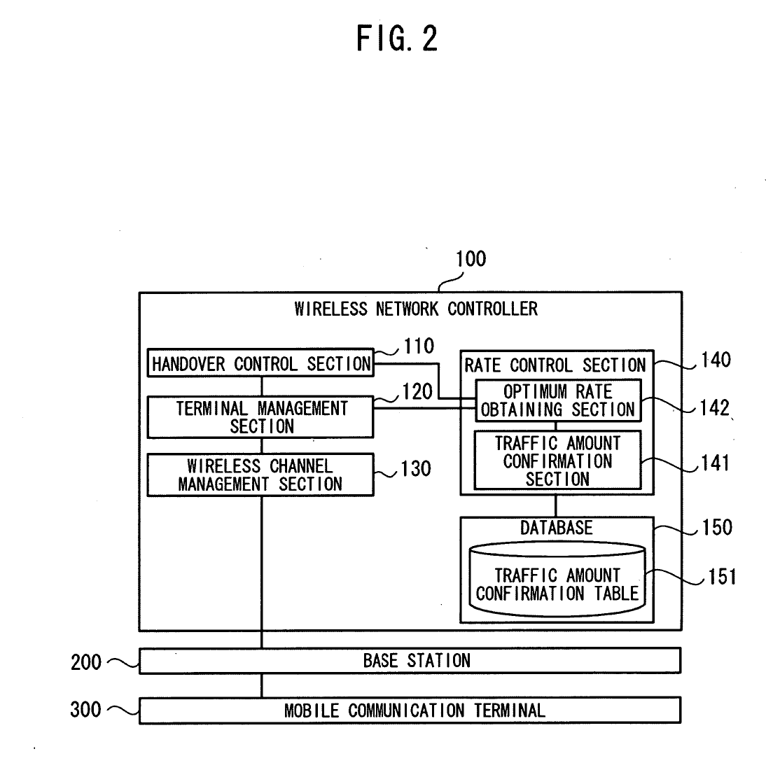

FIG. 2 is a block diagram illustrating the details of the wireless network controller 100 illustrated in FIG. 1.

FIG. 2 illustrates the mobile communication terminal 300. FIG. 2 also illustrates the base station that performs wireless communication with the mobile communication terminal 300. A conceptual base station 200 that ignores the differences among the three base stations illustrated in FIG. 1 is illustrated in FIG. 2.

The wireless network controller 100 illustrated in FIG. 2 has a handover control section 110, a terminal management section 120, a wireless channel management section 130, a rate control section 140 and a database 150. The handover control section 110 carries out handover and handover rate control (described below) separately from periodic rate control. The terminal management section 120 exchanges various kinds of information with the mobile communication terminal 300 via the base station 200. The wireless channel management section 130 designates, for the base station 200, a wireless channel that is used to communicate with the mobile communication terminal 300. The rate control section 140 obtains a communication rate corresponding to the amount of traffic to perform both periodic rate control and handover rate control. The database 150 is referred to by the rate control section 140 for the rate control. In addition, the rate control section 140 has a traffic amount confirmation section 141 and an optimum rate obtaining section 142. The traffic amount confirmation section 141 confirms the traffic amount of the wireless communication between the base station 200 and the mobile communication terminal 300 by referring to the database 150. The optimum rate obtaining section 142 obtains the communication rate corresponding to the traffic amount confirmed using the traffic amount confirmation section 141. Furthermore, the database 150 includes a traffic amount confirmation table 151 in which the communication history of the wireless communication between the base station 200 and the mobile communication terminal 300 is stored so as to be used to confirm the traffic amount of the wireless communication.

In this configuration, the combination of the handover control section 110 and the traffic amount confirmation section 141 corresponds to an example of the traffic amount confirmation section referred to in this embodiment, and the combination of the handover control section 110, the terminal management section 120, the wireless channel management section 130, and the optimum rate obtaining section 142 corresponds to an example of the communication request section referred to in this embodiment.

In the wireless network controller 100 illustrated in FIG. 2, the rate control for the wireless communication is repeated periodically at given time intervals to effectively utilize wireless communication resources while communication is performed between the base station 200 and the mobile communication terminal 300.

In this configuration, for example, as in the example of FIG. 1 described above, the mobile communication terminal 300 moves from the A-cell 201_A to the B-cell 201_B. The wireless network controller 100 carries out handover in which the base station communicating with the mobile communication terminal 300 is switched from the A-base station 200_A to the B-base station 200_B. In addition, in this embodiment, at the time of this handover, the rate control for the next handover is carried out. The wireless network controller 100 confirms the traffic amount of the wireless communication between the mobile communication terminal 300 and the A-base station 200_A that was used before switching. The wireless network controller 100 instructs the switching destination B-base station 200_B to assign a wireless channel having the communication rate corresponding to the traffic amount thereof to the mobile communication terminal 300. In doing so, the wireless network controller 100 according to this embodiment carries out a handover in which the waste of the wireless communication resources is reduced. With the use of the wireless network controller 100 according to this embodiment, a handover that is normally performed successfully can be carried out without failure.

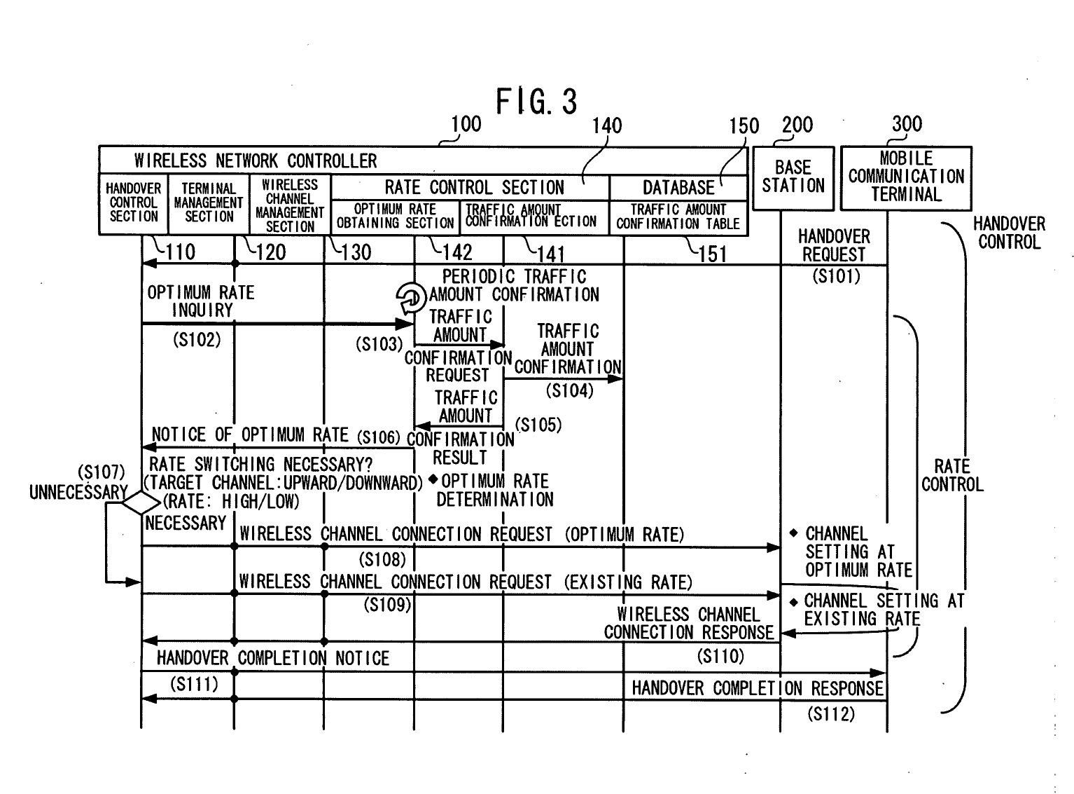

FIG. 3 is a view illustrating the handover processing sequence in the wireless network controller illustrated in FIGS. 1 and 2.

The mobile communication terminal 300 is communicating with a base station 200. A case in which the mobile communication terminal 300 has moved from the base station 200 to another base station 200 is described below. The mobile communication terminal 300 transmits a handover request for requesting base station switching to the wireless network controller 100 (operation S101). At this time, the mobile communication terminal 300 measures the electric field intensity of the above-mentioned pilot signal received from the base station 200 currently communicating therewith. The mobile communication terminal 300 also measures the electric field intensity of the pilot signal received from the other base station 200. The mobile communication terminal 300 compares the electric field intensities of the two pilot signals. Furthermore, the mobile communication terminal 300 recognizes the movement between the cells on the basis of the result of the comparison. The above-mentioned handover request is transmitted via the base station 200 that was used before switching.

The handover request transmitted from the mobile communication terminal 300 is received by the handover control section 110 of the wireless network controller 100 via the terminal management section 120. Then, in this embodiment, the handover control section 110 asks the optimum rate obtaining section 142 provided in the rate control section 140 for a suitable communication rate for the traffic amount at the current time (operation S102).

While communication is performed between the base station 200 and the mobile communication terminal 300, the rate control for the communication is repeated periodically at given time intervals as described above.

In this embodiment, when the terminal management section 120 inquires about the communication rate, the optimum rate obtaining section 142 requests the traffic amount confirmation section 141 to confirm the traffic amount (operation S103). This request is issued regardless of the periodic timing of the rate control. The traffic amount confirmation section 141 confirms the traffic amount of the wireless communication between the base station 200 and the mobile communication terminal 300 by performing calculation on the basis of the communication history having been stored in the traffic amount confirmation table 151 up to the current time (operation S104). The traffic amount confirmation section 141 transmits the traffic amount information obtained as the result of the confirmation to the optimum rate obtaining section 142 (operation S105). The optimum rate obtaining section 142 obtains the communication rate suited for the traffic amount transmitted from the traffic amount confirmation section 141 as described below and transmits the communication rate to the handover control section 110 (operation S106).

A preferable traffic amount range in which appropriate communication is possible at the communication rate of each wireless channel is associated with each of the multiple wireless channels of the base station 200. The optimum rate obtaining section 142 obtains the communication rate of the wireless channel corresponding to the range to which the traffic amount transmitted from the traffic amount confirmation section 141 belongs as the communication rate corresponding to the traffic amount. As a result, in the case that the transmitted traffic amount is more than the upper limit traffic amount in the traffic amount range corresponding to the wireless channel of the current time, a communication rate higher than the communication rate of the wireless channel of the current time is obtained. Conversely, in the case that the transmitted traffic amount is less than the lower limit traffic amount in the above-mentioned range, a communication rate lower than the communication rate of the wireless channel of the current time is obtained.

Strictly speaking, the communication between the mobile communication terminal 300 and the base station 200 is classified into upward wireless communication and downward wireless communication. The upward wireless communication is communication in which electric wave signals are transmitted from the mobile communication terminal 300 to the base station 200. Conversely, the downward wireless communication is communication in which electric wave signals are transmitted from the base station 200 to the mobile communication terminal 300. These two kinds of communication relating to the mobile communication terminal 300 are performed concurrently using wireless channels independent of each other. In this embodiment, the processing from the above-mentioned operation S102 to operation S106 is carried out for both the upward wireless communication and the downward wireless communication. In this embodiment, the communication rate corresponding to the traffic amount of the upward wireless communication and the communication rate corresponding to the traffic amount of the downward wireless communication are transmitted to the handover control section 110.

When these two communication rates are transmitted, the handover control section 110 compares the communication rates with the communication rate of the upward wireless communication at the current time and the communication rate of the downward wireless communication at the current time. In the case that the communication rate transmitted for the upward wireless communication is different from the communication rate of the current time, the handover control section 110 judges that wireless channel switching is necessary for the upward wireless communication. In the case that the communication rate transmitted for the downward wireless communication is different from the communication rate of the current time, the handover control section 110 judges that wireless channel switching is necessary for the downward wireless communication (operation S107). Furthermore, in the case of the wireless communication in which the transmitted communication rate matches the communication rate of the current time, the handover control section 110 judges that wireless channel switching is unnecessary.

The handover control section 110 transmits a wireless channel connection request for the upward wireless communication or the downward wireless communication in which wireless channel switching is judged to be necessary. The handover control section 110 transmits the wireless channel connection request to the switching destination base station 200 designated in the above-mentioned handover request. The handover control section 110 transmits the wireless channel connection request to instruct that connection is carried out to the mobile communication terminal 300 using the wireless channel having the communication rate transmitted from the optimum rate obtaining section 142. The handover control section 110 transmits the wireless channel connection request via the terminal management section 120 and the wireless channel management section 130 (operation S108). On the other hand, the handover control section 110 transmits a wireless channel connection request for the upward wireless communication or the downward wireless communication in which wireless channel switching is judged to be unnecessary. The wireless channel designated in this connection request is a wireless channel having the same or almost the same communication rate as the communication rate of the wireless channel being used at the current time for the communication between the mobile communication terminal 300 and the base station 200 that was used before switching. The handover control section 110 transmits the wireless channel connection request to instruct that connection is carried out to the mobile communication terminal 300 using the wireless channel. The handover control section 110 transmits the wireless channel connection request to the switching destination base station 200 via the terminal management section 120 and the wireless channel management section 130 (operation S109).

The switching destination base station 200 is connected to the mobile communication terminal 300 for the upward wireless communication and the downward wireless communication using the wireless channel according to the above-mentioned wireless channel connection requests. Then, the switching destination base station 200 transmits a wireless channel connection response. The wireless channel connection response is used to report that the connection to the mobile communication terminal 300 has been established. The switching destination base station 200 transmits the wireless channel connection response to the handover control section 110. The switching destination base station 200 transmits the wireless channel connection response via the terminal management section 120 and the wireless channel management section 130 (operation S110). After receiving the wireless channel connection response from the switching destination base station 200, the handover control section 110 instructs the base station 200 that was used before switching to release the wireless channel. The handover control section 110 orders the release of the wireless channel having been used so far for the communication with the mobile communication terminal 300. The handover control section 110 transmits a handover completion notice to the mobile communication terminal 300. The handover control section 110 transmits the notice via the terminal management section 120 and the switching destination base station 200. The handover completion notice is used to report that handover has been completed (operation S111). After receiving the handover completion notice, the mobile communication terminal 300 transmits a handover completion response informing the handover control section 110 that the notice has been understood via the switching destination base station 200 and the terminal management section 120 (operation S112).

As described above, in this embodiment, handover rate control is carried out at the time of handover regardless of the periodic rate control. As a result, as described below, waste of the wireless communication resources at the switching destination base station 200 is reduced, and handover that is normally performed successfully can be carried out without failure.

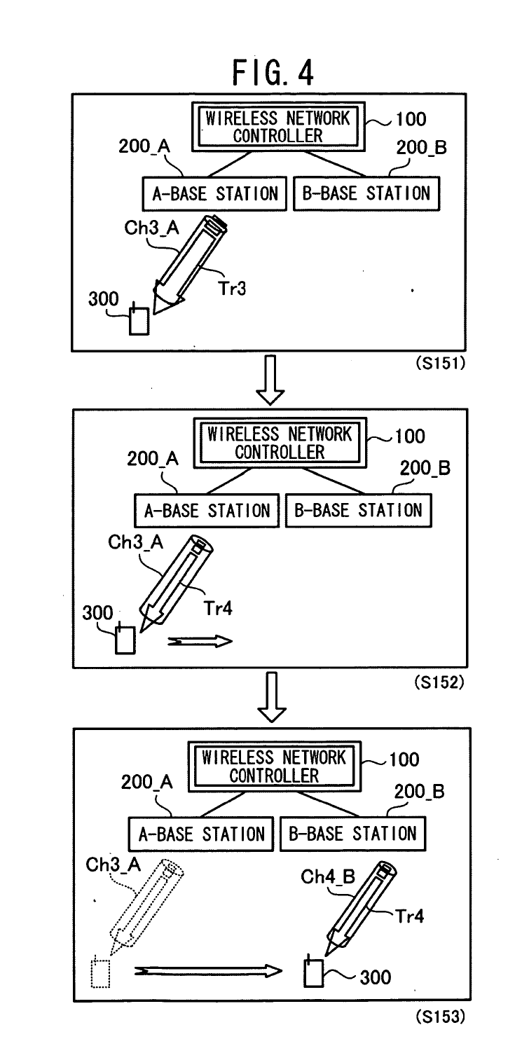

FIG. 4 is a view conceptually illustrating the handover indicated by the processing sequence illustrated in FIG. 3 while paying attention to the communication rate. However, in FIG. 4, attention is paid only to the downward wireless communication among the upward and downward wireless communication for the sake of simplicity of explanation.

First, a case in which the mobile communication terminal 300 is located inside the cell of the A-base station 200_A and is communicating with the A-base station 200_A will be described below (operation S151). At this time, the traffic amount of the wireless communication between the mobile communication terminal 300 and the A-base station 200_A is a large traffic amount Tr3. In the A-base station 200_A, a wireless channel (high rate channel) Ch3_A having a high communication rate has been assigned to the mobile communication terminal 300 by periodic rate control.

A case in which the mobile communication terminal 300 is moving toward the cell of the B-base station 200_B will be described below. During the movement, the traffic amount of the wireless communication between the mobile communication terminal 300 and the A-base station 200_A is reduced. The traffic amount is reduced to a sufficiently small traffic amount Tr4 at a wireless channel (low rate channel) having a low communication rate (operation S152). At this time, the high rate channel Ch3_A still remains used until the periodic rate control timing is reached. Even if the traffic amount of the wireless communication is reduced as described above, the high rate channel Ch3_A is still used.

A case in which the mobile communication terminal 300 has moved at this time to the cell of the B-base station 200_B before the rate control timing is reached will be described below. The mobile communication terminal 300 transmits a handover request. Handover is carried out according to the handover request (operation S153). In this embodiment, rate control is carried out at the time of handover as illustrated in the processing sequence of FIG. 3. In this embodiment, handover rate control is carried out regardless of the periodic rate control. In other words, in this embodiment, the rate control is carried out when the base station is switched for the handover. In this embodiment, the traffic amount is confirmed at the A-base station 200_A that was used before switching. In this embodiment, the traffic amount is confirmed regardless of the above-mentioned periodic rate control timing. In this embodiment, the communication rate is judged depending on the confirmed traffic amount. Furthermore, in this embodiment, the switching destination B-base station 200_B is connected to the mobile communication terminal 300 using the wireless channel having the obtained communication rate. As a result, in the example illustrated in FIG. 4, the switching destination B-base station 200_B is connected to the mobile communication terminal 300 using a low rate channel Ch4_B corresponding to the small traffic amount Tr4 at operation S153.

As described above, in this embodiment, since the wireless channel having the communication rate corresponding to the traffic amount at the time of the handover is used at the switching destination base station at the time of the handover, waste of the wireless communication resources at the switching destination base station is reduced. Furthermore, in this embodiment, in the case that the traffic amount is reduced at the time of the handover to the extent that a wireless channel having a low communication rate may be used sufficiently, a wireless channel having the low communication rate corresponding to the traffic amount may be used at the switching destination base station. Hence, the problem of forcibly trying to use a wireless channel having a high communication rate when a wireless channel having a high communication rate is not available is avoided, and a handover that is normally performed successfully may be carried out without problems. Moreover, in this embodiment, since the periodic rate control can be carried out at conventional time intervals, processing is simple. As described above, in this embodiment, handover in which the waste of the wireless communication resources is reduced may be carried out simply, and a handover that is normally performed successfully may be carried out without fail.

Next, a second embodiment will be described below.

This second embodiment is similar to the above-mentioned first embodiment, except that the second embodiment is equipped with two wireless network controllers being connected to each other. The second embodiment will be described below while paying attention to the differences from the first embodiment.

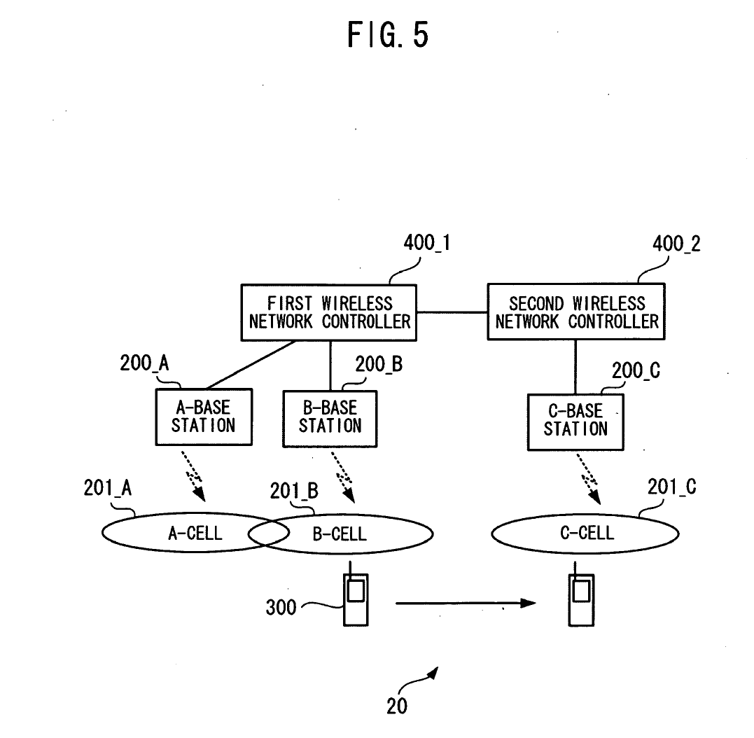

FIG. 5 is a schematic view illustrating an example of a wireless communication system to which the second embodiment has been applied. FIG. 5 is a schematic view illustrating how handover is carried out. In FIG. 5, components similar to those illustrated in FIG. 1 described above are designated by the same codes used in FIG. 1. Overlapping descriptions are omitted in the following descriptions.

The wireless communication system 20 illustrated in FIG. 5 is equipped with first and second wireless network controllers 400_1 and 400_2 connected to each other. The first wireless network controller 400_1 controls the A-base station 200_A and the B-base station 200_B. The second wireless network controller 400_2 controls the C-base station 200_C. However, the first wireless network controller 400_1 may control numerous base stations other than the two base stations illustrated in the figure. The second wireless network controller 400_2 may control numerous base stations other than the one base station illustrated in the figure. Furthermore, the wireless communication system 20 may be equipped with numerous wireless control network controllers other than the two wireless network controllers. In FIG. 5, the two wireless network controllers and the three base stations described above are illustrated as representatives for the sake of simplicity of illustration.

The wireless communication system 20 illustrated in FIG. 5 corresponds to an embodiment of the wireless communication system. The first and second wireless network controllers 400_1 and 400_2 respectively correspond to an embodiment of the wireless network controller. In addition, in this embodiment, the network comprises two groups of base stations: one group of numerous base stations including the A-base station 200_A and the B-base station 200_B, and the other group of numerous base stations including the C-base station 200_C; and one group of numerous wireless communication network controllers including the first and second wireless network controllers 400_1 and 400_2 corresponding to an example of the wireless network referred to in this embodiment.

In this embodiment, the first and second wireless network controllers 400_1 and 400_2 illustrated in FIG. 5 have configurations similar to each other.

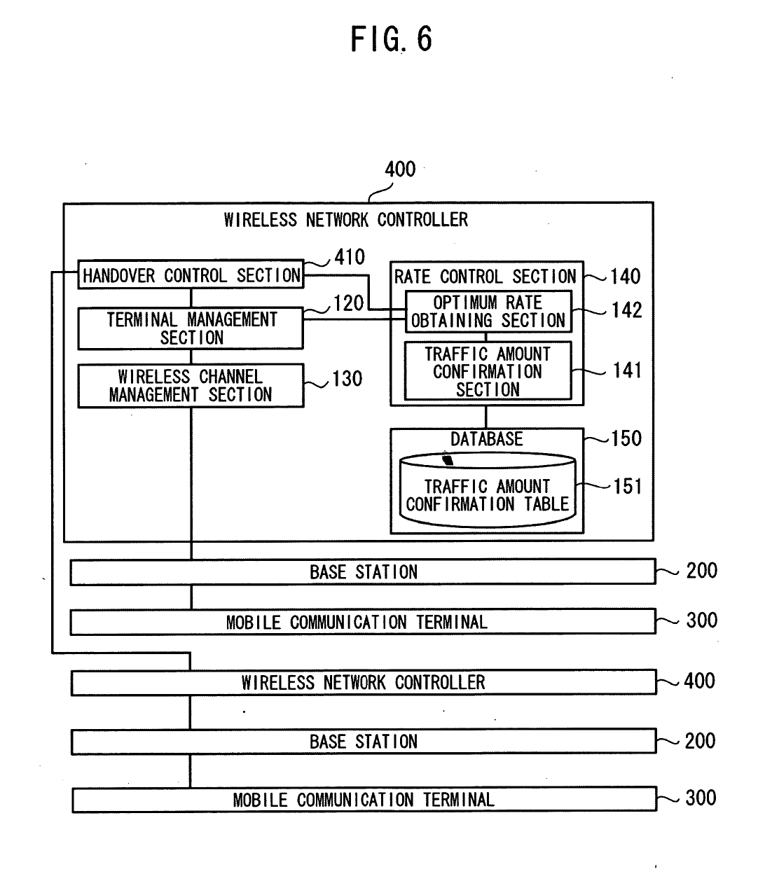

FIG. 6 is a block diagram illustrating the details of the two wireless network controllers illustrated in FIG. 5. FIG. 6 is a block diagram illustrating a concept obtained by ignoring the differences between the two wireless network controllers. In FIG. 6, components similar to those illustrated in FIG. 2 described above are designated by the same codes used in FIG. 2. Overlapping descriptions are omitted in the following descriptions.

The wireless network controller 400 illustrated in FIG. 6 is equipped with a handover control section 410. The handover control section 410 carries out handover not only between a base station 200 that is under the control of the control section, but also between a base station 200 that is under the control of the control section and a base station 200 that is under the control of another control section. In this configuration, the combination of the handover control section 410 and the traffic amount confirmation section 141 corresponds to an example of the traffic amount confirmation section referred to in this embodiment. The combination of the handover control section 410, the terminal management section 120, the wireless channel management section 130, and the optimum rate obtaining section 142 corresponds to an example of the communication request section referred to in this embodiment.

Since the processing of the handover carried out between the base stations 200 that are under the control of the control section is the same processing of the handover as that in the above-mentioned first embodiment, the description of the processing of the handover carried out between the base stations 200 that are under the control of the control section is not repeated and is omitted. The following descriptions pay attention to the processing of the handover carried out between the base station 200 that is under the control of the control section and a base station 200 that is under the control of another control section.

For example, it is assumed that the mobile communication terminal 300 has moved from the B-cell 201_B to the C-cell 201_C as in the example of FIG. 5 described above. The B-cell 201_B is the cell of the B-base station 200_B under the control of the first wireless network controller 400_1. The C-cell 201_C is the cell of the C-base station 200_C under the control of the second wireless network controller 400_2. Then, the first wireless network controller 400_1 carries out handover in which the B-base station 200_B is switched to the C-base station 200_C. The B-base station 200_B is a base station that performs wireless communication with the mobile communication terminal 300. The B-base station 200_B is a base station under the control of the first wireless network controller 400_1. The C-base station 200_C is a base station under the control of the second wireless network controller 400_2. Furthermore, at the time of this handover, the traffic amount of the wireless communication between the mobile communication terminal 300 and the B-base station 200_B that was used before switching is confirmed. Moreover, at the time of this handover, the switching destination C-base station 200_C is instructed to assign a wireless channel having the communication rate corresponding to the traffic amount thereof to the mobile communication terminal 300. With this processing, handover is carried out in which waste of the wireless communication resources is reduced. In addition, with this processing, a handover that is normally performed successfully is carried out without failure.

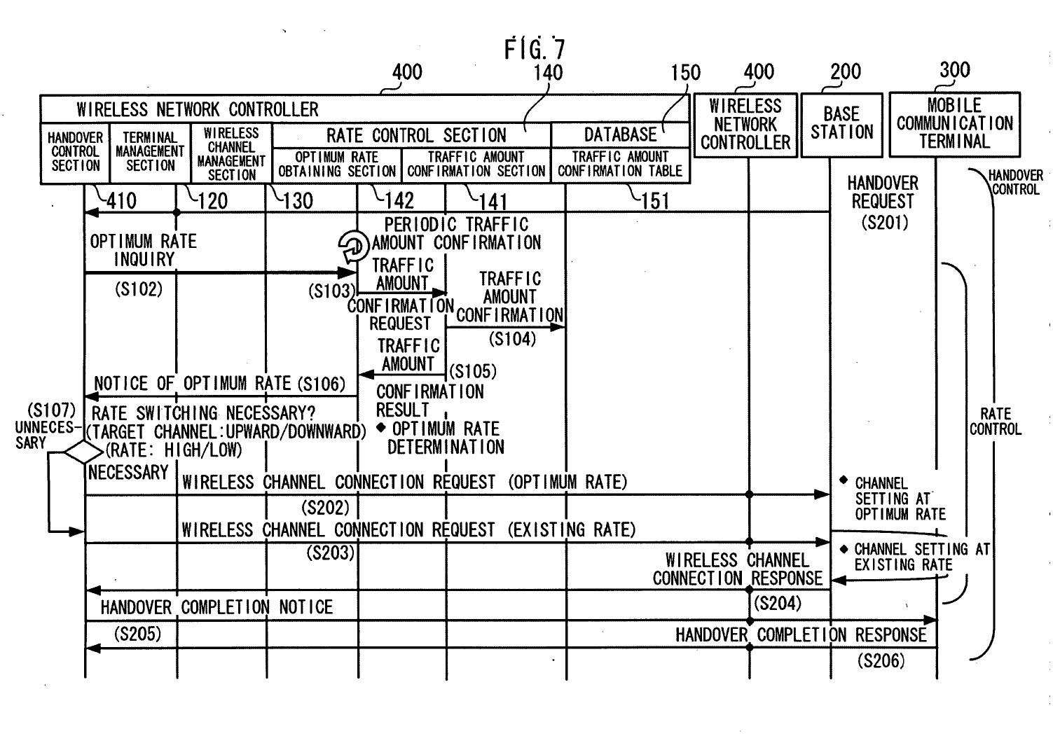

FIG. 7 is a view illustrating the handover processing sequence in the wireless network controller illustrated in FIGS. 5 and 6. The processing steps illustrated in FIG. 7 similar to those illustrated in FIG. 3 described above are designated by the same codes as those illustrated in FIG. 3. Overlapping descriptions are omitted in the following descriptions.

A wireless network controller 400 includes a base station 200. In the case that the mobile communication terminal 300 communicating with the base station 200 has moved from the cell of the base station 200 to the cell of a base station 200 under the control of another wireless network controller 400, the mobile communication terminal 300 transmits a handover request for requesting base station switching to the original wireless network controller 400 (operation S201).

This handover request is received by the handover control section 410 provided in the former wireless network controller 400 via the terminal management section 120. Then, the same processing as the processing from operation S102 to operation S107 illustrated in FIG. 3 is carried out in this embodiment. After the processing, a judgment as to whether wireless channel switching is necessary or not is made for each upward wireless communication and each downward wireless communication related to the mobile communication terminal 300.

The handover control section 410 transmits a wireless channel connection request for the upward wireless communication or the downward wireless communication in which wireless channel switching is judged to be necessary. The handover control section 410 transmits the wireless channel connection request to the switching destination base station 200 designated in the above-mentioned handover request. The handover control section 410 transmits the wireless channel connection request to instruct that connection is carried out to the mobile communication terminal 300 using the wireless channel having the communication rate transmitted from the optimum rate obtaining section 142. The handover control section 410 transmits the wireless channel connection request via the other wireless network controller 400 controlling the switching destination base station 200 (operation S202). In addition, the handover control section 410 transmits a wireless channel connection request for the wireless communication in which wireless channel switching is judged to be unnecessary. The wireless channel designated in this connection request is a wireless channel having the same communication rate as the communication rate of the wireless channel being used at the current time for the communication between the mobile communication terminal 300 and the base station 200 that was used before switching. The handover control section 410 transmits the wireless channel connection request to instruct that connection is carried out to the mobile communication terminal 300 using the wireless channel. The handover control section 410 transmits the wireless channel connection request via the above-mentioned other wireless network controller 400 (operation S203).

The switching destination base station 200 is connected to the mobile communication terminal 300 for the upward wireless communication and downward wireless communication using the wireless channel according to the above-mentioned wireless channel connection request. Then, the switching destination base station 200 transmits a wireless channel connection response. The wireless channel connection response is used to inform the mobile communication terminal 300 that the connection has been established. The switching destination base station 200 transmits the wireless channel connection response to the handover control section 410 of the former wireless network controller 400 controlling the base station 200 that was used before switching. The switching destination base station 200 transmits the wireless channel connection response via the above-mentioned other wireless network controller 400 (operation S204).

After receiving the wireless channel connection response from the switching destination base station 200, the handover control section 410 of the former wireless network controller 400 instructs the base station 200 that was used before switching to release the wireless channel. The handover control section 410 orders the release of the wireless channel having been used so far for the communication with the mobile communication terminal 300. The handover control section 410 transmits a handover completion notice to the mobile communication terminal 300. The completion notice is used to report that the handover has been completed. The handover control section 410 transmits the handover completion notice to the mobile communication terminal 300 via the above-mentioned other wireless network controller 400 (operation S205). Furthermore, after receiving the handover completion notice, the mobile communication terminal 300 transmits a handover completion response. The handover completion response reports that the notice has been understood. The mobile communication terminal 300 transmits the handover completion response via the handover control section 410 of the former wireless network controller 400 and the above-mentioned other wireless network controller 400 (operation S206).

As described above, in this embodiment, even in the case that the mobile communication terminal has moved from the cell of a base station 200 under the control of a wireless network controller 400 to the cell of a base station 200 under the control of another wireless network controller 400, handover rate control is carried out at the time of handover regardless of the periodic rate control. As a result, as described below, waste of the wireless communication resources at the switching destination base station 200 is reduced, and handover that is normally performed successfully is carried out without fail.

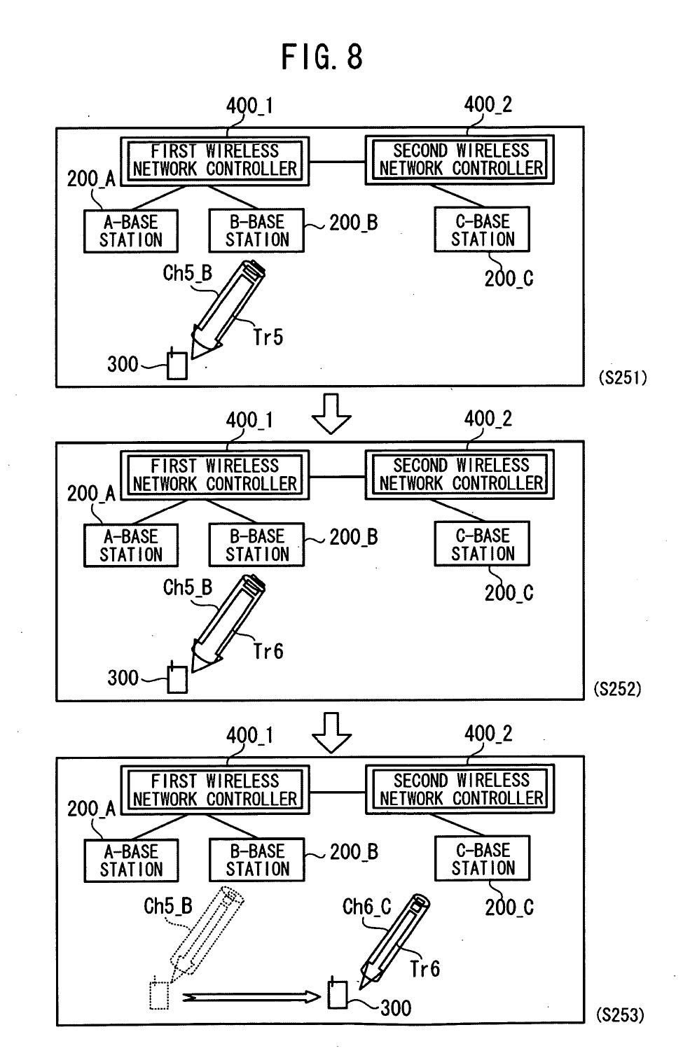

FIG. 8 is a view conceptually illustrating the handover indicated by the processing sequence illustrated in FIG. 7 while paying attention to the communication rate. However, in FIG. 8, attention is paid only to the downward wireless communication among the upward and the downward wireless communication for the sake of simplicity of explanation.

First, the mobile communication terminal 300 is located inside the cell of the B-base station 200_B under the control of the first wireless network controller 400_1 and is communicating with the B-base station 200_B (operation S251). At this time, the traffic amount of the wireless communication between the mobile communication terminal 300 and the B-base station 200_B is a large traffic amount Tr5. In the B-base station 200B, a wireless channel (high rate channel) Ch5_B having a high communication rate is assigned to the mobile communication terminal 300 by the above-mentioned rate control.

A case in which the mobile communication terminal 300 is moving toward the cell of the C-base station 200_C under the control of the second wireless network controller 400_2 will be described below. During the movement, the traffic amount of the wireless communication between the mobile communication terminal 300 and the B-base station 200_B is reduced. The traffic amount is reduced to a sufficiently small traffic amount Tr6, at a wireless channel (low rate channel) having a low communication rate (operation S252). At this time, the high rate channel Ch5_B still remains used until the periodic rate control timing is reached. Even if the traffic amount of the wireless communication is reduced as described above, the high rate channel Ch5_B still remains in use.

A case in which the mobile communication terminal 300 has moved at this time to the cell of the C-base station 200_C under the control of the second wireless network controller 400_2 before the rate control timing is reached will be described below. The mobile communication terminal 300 transmits a handover request. Handover is carried out in response to the handover request (operation S253). In this embodiment, rate control is carried out at the time of handover as illustrated in the processing sequence of FIG. 7. This rate control is carried out even when the mobile communication terminal 300 has moved from the cell of a base station 200 under the control of a wireless network controller 400 to the cell of a base station 200 under the control of another wireless network controller 400. The rate control is carried out at the time of handover regardless of the periodic rate control. In other words, in this embodiment, the traffic amount is confirmed when the base station is switched for the handover. In this embodiment, the traffic amount is confirmed at the B-base station 200_B that was used before switching. In this embodiment, the traffic amount is confirmed regardless of the above-mentioned periodic rate control timing. In this embodiment, the traffic amount is confirmed, and the communication rate corresponding to the confirmed traffic amount is obtained. In this embodiment, the switching destination C-base station 200_C is connected to the mobile communication terminal 300. A wireless channel having the obtained communication rate is used for the connection. As a result, in the example illustrated in FIG. 8, the switching destination C-base station 200_C under the control of the second wireless network controller 400_2 is connected to the mobile communication terminal 300 using a low rate channel Ch6_C corresponding to the small traffic amount Tr6 at operation S253.

As described above, with this embodiment, the wireless network controller 400 can simply carry out the handover between the base stations 200 under the control of the controller while reducing waste of the wireless communication resources, and also the handover between the base station 200 under the control of the controller and a base station 200 under the control of another controller while reducing waste of the wireless communication resources. Furthermore, in this embodiment, at the time the handover is carried out between the base stations 200 under the control of the controller, the problem of forcibly trying to use a wireless channel having a high communication rate is avoided. Moreover, even when a handover is carried out between the base station 200 under the control of the controller and the base station 200 under the control of the other controller, the handover can be carried out without problems.

Although the case in which the mobile communication terminal requests to communicate with another base station in when communication with another base station becomes necessary according to this embodiment has been taken as an example in the above-mentioned descriptions, this embodiment is not limited to this case. When communication with another base station becomes necessary according to this embodiment may be when the wireless network controller judges that the mobile communication terminal being used for communication is required to communicate with another base station.

Furthermore, as an example of the communication request section according to this embodiment, when the confirmed traffic amount is more than the upper limit traffic amount in the traffic amount range corresponding to the wireless channel which is used by the mobile communication terminal and whose traffic amount has been confirmed, an example in which communication using a wireless channel having a communication rate higher than the communication rate of the wireless channel is requested for the handover switching destination base station has been described. Also, in the case that the confirmed traffic amount is less than the lower limit traffic amount in the traffic amount range, an example in which communication using a wireless channel having a communication rate lower than the communication rate of the wireless channel is requested has been described. However, this embodiment is not limited to these descriptions. The communication request section according to this embodiment may be configured, for example, such that in the case that the confirmed traffic amount is more than the upper limit traffic amount, the communication request section may request communication using a wireless channel having a high communication rate, and such that in the case that the confirmed traffic amount is less than the lower limit traffic amount, the communication request section may request communication using a wireless channel having the same or almost the same communication rate as the communication rate of the wireless channel being used at the current time. Alternatively, the communication request section may also be configured such that in the case that the confirmed traffic amount is less than the lower limit traffic amount, the communication request section may request communication using a wireless channel having a communication rate lower than the communication rate of the wireless channel thereof, and such that in the case that the confirmed traffic amount is more than the upper limit traffic amount, the communication request section may request communication using a wireless channel having the same communication rate as the communication rate of the wireless channel being used at the current time.

Still further, in the above descriptions, as an example of the communication request section according to this embodiment, an example in which for the handover switching destination base station, communication using a wireless channel corresponding to the traffic amount is requested for both upward wireless communication and downward wireless communication. However, this embodiment is not limited to this. The communication request section according to this embodiment may also be configured, for example, to request communication using a wireless channel corresponding to the traffic amount for either one of upward wireless communication and downward wireless communication, and to request communication using a wireless channel having the same or almost the same communication rate as the communication rate of the wireless channel being used at the current time for the other wireless communication.

### Comparison Example 1

A wireless network in which handover and periodic rate control are carried out independently of each other will be described below.

Each base station performs wireless communication with a mobile communication terminal located inside a cell in which wireless communication can be performed as seen from the base station. Hence, in the case that a mobile communication terminal communicating with a base station has moved from the cell of the base station to the cell of another base station, the base station that performs wireless communication with the mobile communication terminal needs to be switched. This base station switching is referred to as handover. A wireless network controller controls multiple base stations. The wireless network controller controls the base stations and carries out handover.

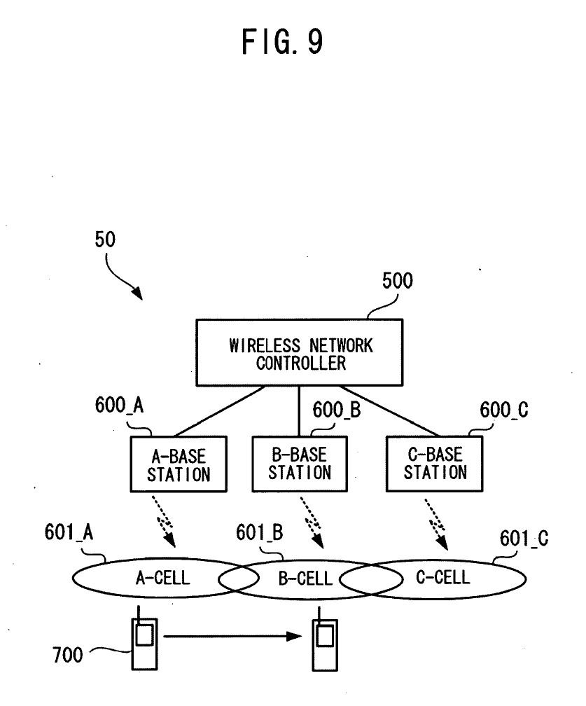

FIG. 9 is a view illustrating how handover is carried out.

FIG. 9 illustrates three base stations: an A-base station 600_A, a B-base station 600_B and a C-base station 600_C. FIG. 9 also illustrates a wireless network controller 500 controlling the three base stations. FIG. 9 also illustrates a mobile communication terminal 700 that communicates with each base station. Furthermore, FIG. 9 illustrates a wireless communication system 50 including the three base stations, the wireless network controller, and the mobile communication terminal. The wireless network controller 500 controls numerous base stations other than the three base stations illustrated in the figure. The wireless communication system 50 also has a plurality of wireless network controllers. In FIG. 9, the one wireless network controller 500 and the three base stations described above are illustrated as representatives.

The A-base station 600_A performs wireless communication with a mobile communication terminal located inside an A-cell 601_A. The B-base station 600_B performs wireless communication with a mobile communication terminal located inside a B-cell 601_B. The C-base station 600_C performs wireless communication with a mobile communication terminal located inside a C-cell 601_C. As illustrated in FIG. 9, the mobile communication terminal 700 moves from the A-cell 601_A to the B-cell 601_B. The wireless network controller 500 carries out handover. The wireless network controller 500 switches the base station that performs wireless communication with the mobile communication terminal 700 from the A-base station 600_A to the B-base station 600_B.

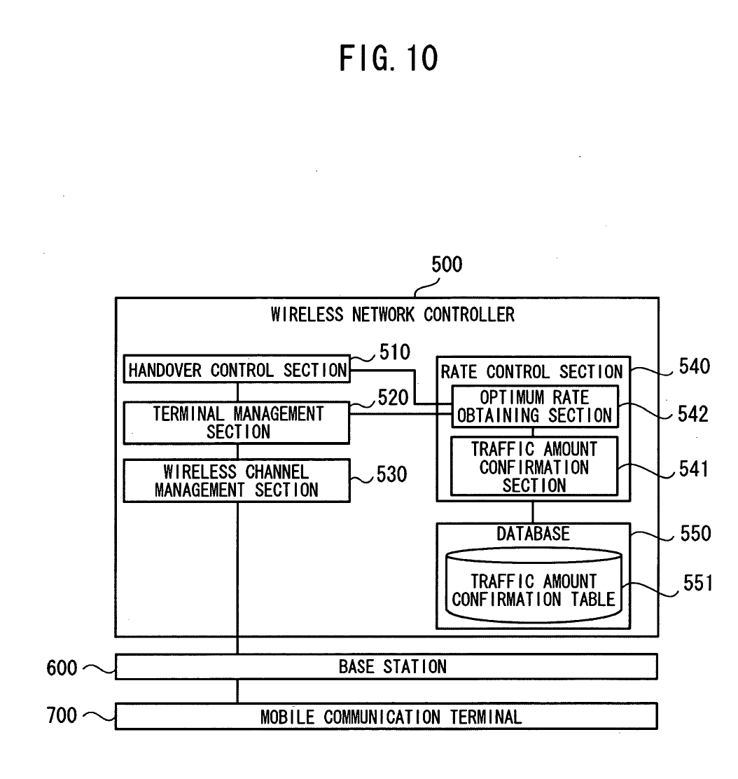

FIG. 10 is a block diagram illustrating the wireless network controller 500. FIG. 10 illustrates the mobile communication terminal 700. FIG. 10 also illustrates a base station that performs wireless communication with the mobile communication terminal 700. This base station illustrates a concept obtained by ignoring the differences among the three base stations illustrated in FIG. 9.

The wireless network controller 500 illustrated in FIG. 10 has a handover control section 510, a terminal management section 520, a wireless channel management section 530, a rate control section 540, and a database 550. The handover control section 510 carries out handover. The terminal management section 520 exchanges various kinds of information with the mobile communication terminal 700 via the base station 600. The wireless channel management section 530 designates, for the base station 600, a wireless channel that is used to communicate with the mobile communication terminal 700. The rate control section 540 obtains a communication rate corresponding to the traffic amount to perform wireless channel switching (rate control) corresponding to the traffic amount. The database 550 is referred to by the rate control section 540 when the communication rate is obtained. In addition, the rate control section 540 has a traffic amount confirmation section 541 and an optimum rate obtaining section 542. The traffic amount confirmation section 541 confirms the traffic amount of the wireless communication between the base station 600 and the mobile communication terminal 700 by referring to the database 550. The optimum rate obtaining section 542 obtains the communication rate corresponding to the traffic amount confirmed using the traffic amount confirmation section 541. Furthermore, the database 550 includes a traffic amount confirmation table 551. In the traffic amount confirmation table 551, the communication history of the wireless communication between the base station 600 and the mobile communication terminal 700 is stored so as to be used to confirm the traffic amount of the wireless communication.

The wireless network controller 500 illustrated in FIG. 10 periodically repeats rate control. The rate control is repeated periodically during the communication between the base station 600 and the mobile communication terminal 700. The rate control is carried out to effectively utilize the wireless communication resources. Furthermore, the rate control is repeated periodically at given time intervals.

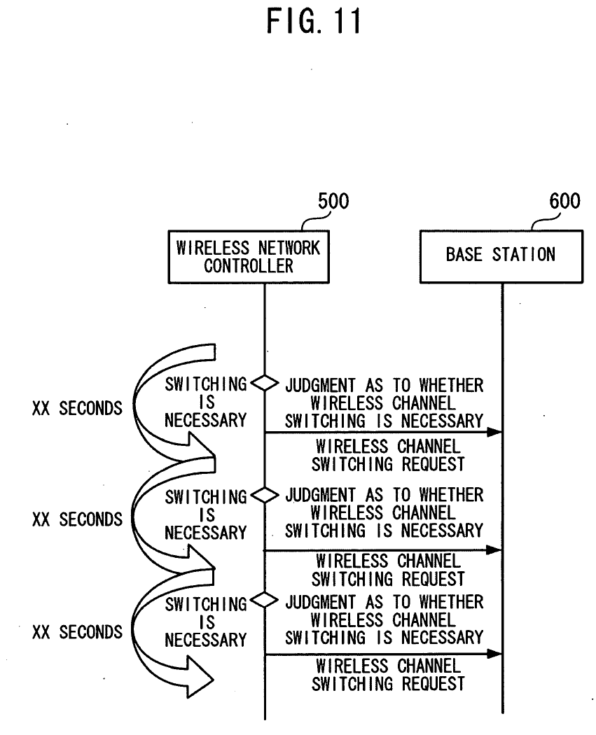

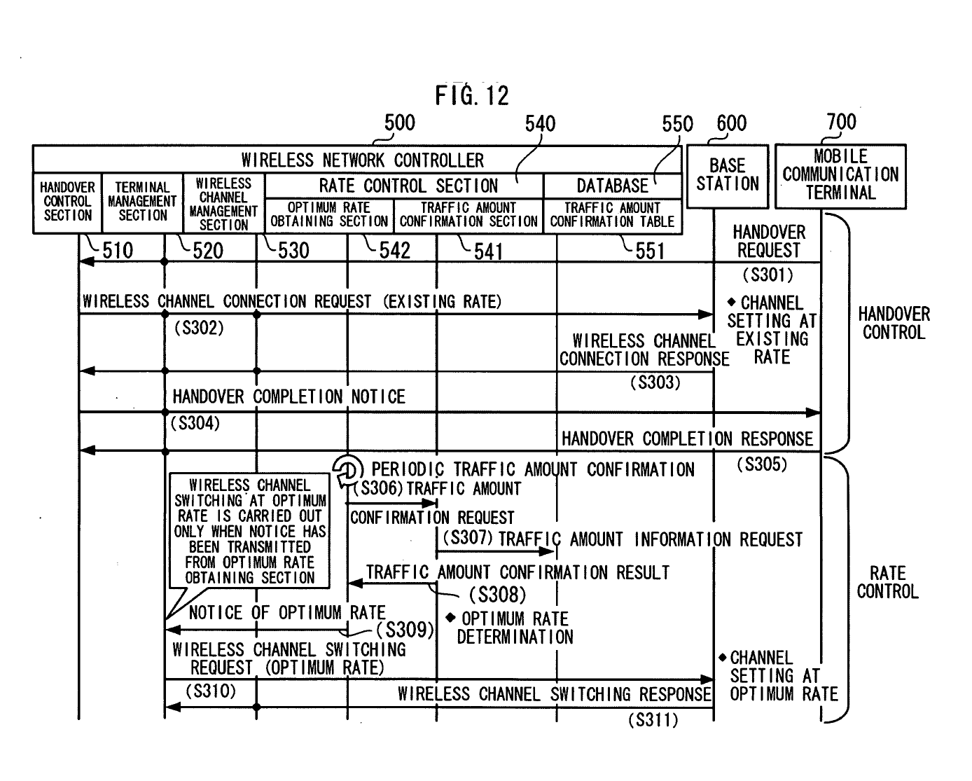

FIG. 11 is a view conceptually illustrating the rate control. FIG. 11 illustrates how the rate control is repeated periodically. FIG. 12 is a view illustrating the processing sequence of the wireless network controller. This processing sequence includes the rate control.

The sequence from operation S306 to operation S311 in FIG. 12 illustrates the processing sequence of the rate control. The sequence from operation S301 to operation S305 in FIG. 4 illustrates the processing sequence of the handover described below. The sequence from operation S301 to operation S305 in FIG. 12 will be referred to again when the processing sequence of the handover is described.

In the example illustrated in FIG. 11, a judgment is made as to whether wireless channel switching is necessary or not. When it is judged that the switching is necessary, wireless channel switching is ordered. The instruction for wireless channel switching is transmitted from the wireless network controller 500 to the base station 600 and is executed for the rate control every XX seconds in the wireless network controller 500.

The following describes the rate control carried out every XX seconds while referring to the processing sequence for the rate control in the sequence from operation S306 to operation S311 of FIG. 12.

When the timing of every XX seconds is reached, the optimum rate obtaining section 542 first requests the traffic amount confirmation section 541 to confirm the traffic amount in the processing at operation S306 illustrated in FIG. 12. The traffic amount confirmation section 541 confirms the traffic amount of the wireless communication between the base station 600 and the mobile communication terminal 700 by performing calculation based on the communication history that was stored up to the current time in the traffic amount confirmation table 551 (operation S307), and transmits the traffic amount obtained as the result of the confirmation to the optimum rate obtaining section 542 (operation S308). The optimum rate obtaining section 542 obtains the communication rate corresponding to the traffic amount transmitted from the traffic amount confirmation section 541. Furthermore, in the case that the obtained communication rate is different from the communication rate of the wireless channel being used at the time, the optimum rate obtaining section 542 judges that wireless channel switching is necessary. In the case that the rates are the same, the optimum rate obtaining section 542 judges that wireless channel switching is not necessary. Moreover, in the case that the optimum rate obtaining section 542 has judged that wireless channel switching is necessary, the optimum rate obtaining section 542 transmits the communication rate corresponding to the above-mentioned traffic amount to the terminal management section 520 (operation S309). When the communication rate is transmitted from the optimum rate obtaining section 542, the terminal management section 520 transmits a wireless channel switching request for requesting switching to a wireless channel having the communication rate to the base station 600 via the wireless channel management section 530 (operation S310). After receiving the wireless channel switching request, the base station 600 carries out wireless channel switching according to the wireless channel switching request and then transmits a wireless channel switching response informing the terminal management section 520 that wireless channel switching has been completed via the wireless channel management section 530 (operation S311).

The processing described above is repeated in the wireless network controller 500. The wireless network controller 500 repeats the rate control every XX seconds. Hence, the wireless communication resources are utilized effectively.

Next, the handover carried out in the wireless network controller 500 in which the above-mentioned rate control is carried out will be described referring to the handover processing sequence from operation S301 to operation S305 illustrated in FIG. 12.

In the case that the mobile communication terminal 700 communicating with a base station 600 has moved from the cell of the base station 600 to the cell of another base station 600, the mobile communication terminal 700 transmits a handover request for requesting base station switching to the wireless network controller 500 (operation S301).

Each base station 600 generates most of the time if not constantly an electric wave signal (pilot signal) having a given output using a given wireless channel. In addition, the mobile communication terminal 700 receives the pilot signal from each base station 600. In the case that another pilot signal having an electric field intensity that is different, by a given value or less, from the electric field intensity of the pilot signal received from the base station 600 being used for communication at the current time is received at this time, it is recognized that the mobile communication terminal is moving to another cell. Then, in the case that the recognition has been completed, the mobile communication terminal 700 transmits a handover request for requesting the switching to the base station 600, which is generating the latter pilot signal, to the wireless network controller 500. This handover request is transmitted via the base station 600 that was used before switching.

The handover request transmitted from the mobile communication terminal 700 is received by the handover control section 510 via the terminal management section 520 in the wireless network controller 500. Then, the handover control section 510 transmits, to the switching destination base station 600 via the terminal management section 520 and the wireless channel management section 530, a wireless channel connection request instructing that the switching destination base station 600 connect to the mobile communication terminal 700 using a wireless channel having the same or almost the same communication rate as the communication rate of the wireless channel being used at the current time for the communication between the base station 600 that was used before switching and the mobile communication terminal 700 (operation S302). The switching destination base station 600 is connected to the mobile communication terminal 700 using the wireless channel according to the wireless channel connection request. Then, the switching destination base station 600 transmits a wireless channel connection response informing the handover control section 510 via the wireless channel management section 530 and the terminal management section 520 that the connection to the mobile communication terminal 700 has been completed (operation S303). After receiving the wireless channel connection response from the switching destination base station 600, the handover control section 510 instructs the base station 600 that was used before switching to release the wireless channel used so far for the communication with the mobile communication terminal 700, and transmits a handover completion notice informing the mobile communication terminal 700 via the terminal management section 520 and via the switching destination base station 600 that the handover has been completed (operation S304). After receiving the handover completion notice, the mobile communication terminal 700 transmits a handover completion response informing the handover control section 510 via the switching destination base station 600 and the terminal management section 520 that the notice has been understood (operation S305).

In the wireless network controller 500, the periodic repetition of the rate control and the handover described above are carried out separately from each other. However, the rate control before the handover is carried out for the wireless communication between the base station 600 that was used before switching and the mobile communication terminal 700, and the rate control after the handover is carried out for the wireless communication between the base station 600 used after the switching and the mobile communication terminal 700.

In the processing sequence illustrated in FIG. 12, the communication rate of the wireless channel that was used for the communication between the base station 600 that was used before switching and the mobile communication terminal 700 is passed on to the communication with the switching destination base station 600 at the time of handover. As a result, as described below, waste in the utilization of the wireless communication resources in the switching destination base station 600 may occur.

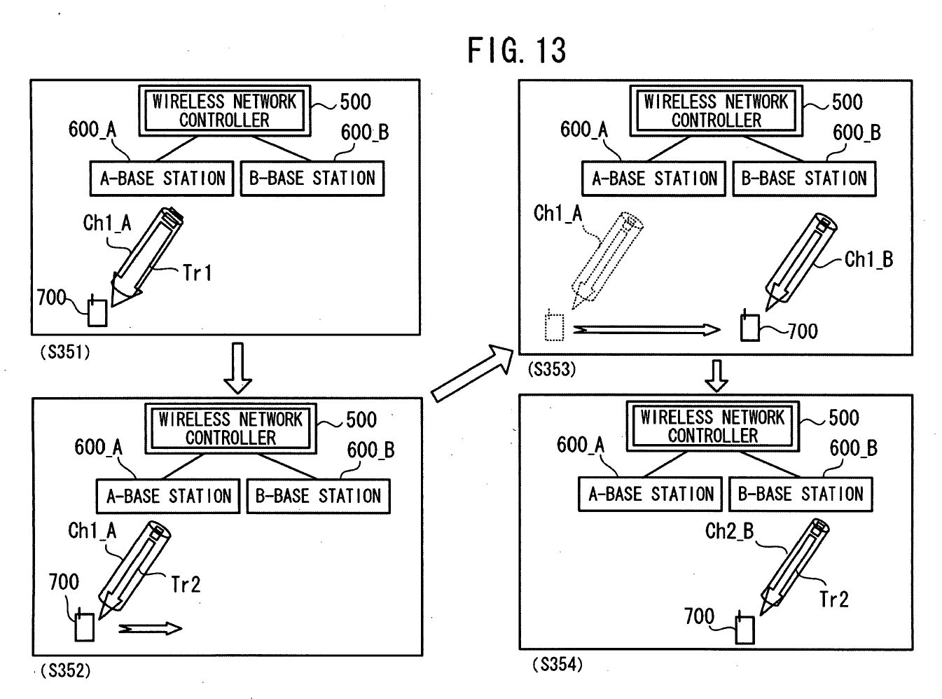

FIG. 13 is a view conceptually illustrating the handover indicated by the processing sequence illustrated in FIG. 12 while paying attention to the communication rate.

First, it is assumed that the mobile communication terminal 700 is located inside the cell of the A-base station 600_A and is communicating with the A-base station 600_A (operation S351). At this time, it is assumed that the traffic amount of the wireless communication between the mobile communication terminal 700 and the A-base station 600_A is a large traffic amount Tr1, and that in the A-base station 600_A, a wireless channel (high rate channel) Ch1_A having a high communication rate has been assigned to the mobile communication terminal 700 by the above-mentioned rate control.

Here, it is assumed that the mobile communication terminal 700 is moving toward the cell of the B-base station 600_B and that during the movement, the traffic amount of the wireless communication between the mobile communication terminal 700 and the A-base station 600_A is reduced to a sufficiently small traffic amount Tr2, at a wireless channel having a low communication rate (operation S352). At this time, the high rate channel Ch1_A still remains used until the periodic rate control timing is reached even if the traffic amount of the wireless communication is reduced as described above.

It is assumed that the mobile communication terminal 700 has moved at this time to the cell of the B-base station 600_B before the rate control timing is reached, that the mobile communication terminal 700 transmits a handover request, and that the handover is carried out according to the handover request (operation S353). As described above, in the processing sequence illustrated in FIG. 12, the communication rate before switching is passed on to the switching destination base station, whereby the high rate channel Ch1_B having the same high communication rate as the communication rate of the high rate channel Ch1_A having been used at the A-base station 600_A is used at the B-base station 600_B.

When the rate control timing is reached after the handover, rate control is carried out for the communication between the switching destination B-base station 600_B and the mobile communication terminal 700. As a result, at the time when the rate control timing is reached, wireless channel switching is carried out from the high rate channel Ch1_B to the wireless channel (low rate channel) Ch2_B having a low communication rate corresponding to the small traffic amount Tr2 (operation S354).

If the reduction in the traffic amount and the handover occur as described above before the rate control timing is reached in the processing sequence illustrated in FIG. 12, there is a problem in which the wireless communication resources are used wastefully until wireless channel switching is carried out in the switching destination B-base station 600_B. Furthermore, in the case that the high rate channel Ch1_B is not available in the switching destination B-base station 600_B, the handover that is normally performed successfully may fail.

### Comparison Example 2

A wireless network in which rate control is carried out at the timing of handover will be described below. However, the handover and the periodic rate control are carried out independently of each other.

When a handover request is transmitted from the mobile communication terminal, the wireless channel in the base station having been used before switching is switched to a wireless channel having the same communication rate as the communication rate of a wireless channel available in the switching destination base station. Handover is then carried out.

With the above-mentioned technology, the problem in which handover fails because the necessary wireless channel is not available in the switching destination base station is avoided. However, with this technology, even if the traffic amount is small, if a wireless channel having a high communication rate is available at the time of handover, there is a possibility that such a wireless channel is used, and so the problem in which the wireless communication resources are used wastefully remains unsolved.

### Comparison Example 3

For the purpose of addressing the problem in which the wireless communication resources are used wastefully at the time of handover, it is conceivable that the repetition time intervals of the periodically repeated rate control may be shortened.

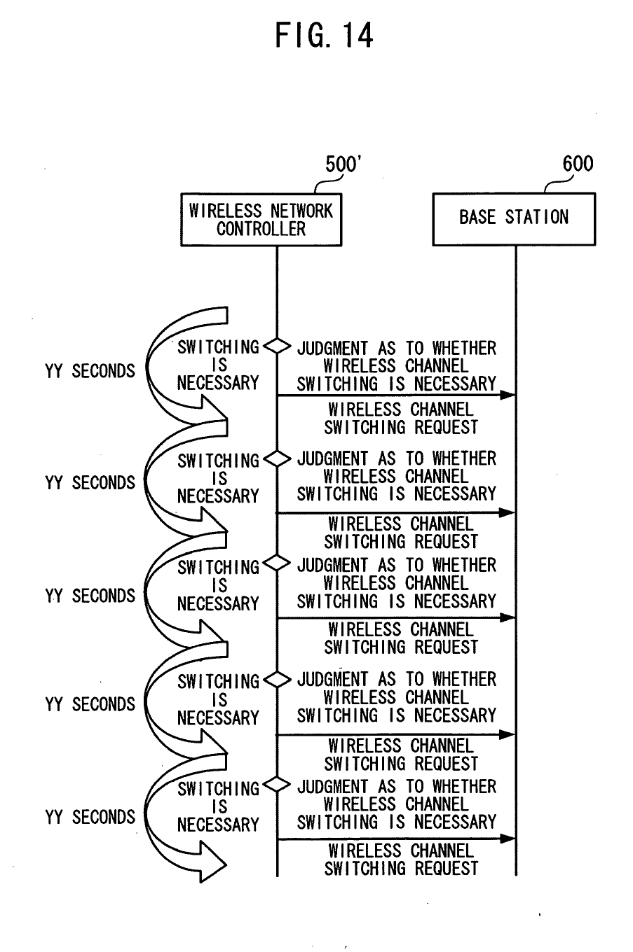

FIG. 14 is a view conceptually illustrating a state in which the repetition time intervals of the periodically repeated rate control are shortened.

In the wireless network controller 500 illustrated in FIG. 14, the judgment as to whether wireless channel switching is necessary or not, and the rate control processing for instructing that wireless channel switching to the base station 600 when it has been judged that the switching is necessary, are carried out at time intervals of every YY seconds, which are shorter than XX seconds, in the wireless network controller 500 illustrated in FIG. 11.

As a result, the probability in which the traffic amount is reduced and the handover occurs before the rate control timing is reached becomes lower, whereby the occurrence of the problem in which the wireless communication resources are used wastefully at the time of handover is reduced. However, by shortening the repetition time intervals, the number of rate control operations increases. As a result, the processing loads in the wireless network controller, etc. increase. Furthermore, with this technology, although the above-mentioned probability becomes lower, it does not become zero. Hence, in the case that the reduction in traffic amount and the occurrence of handover are caused before the timing is reached, the waste of the wireless communication resources eventually occurs at one time or another. Moreover, as a result of obtaining a wireless channel having a wastefully high communication rate, the probability of occurrence of the problem in which handover that is normally performed successfully fails can be reduced to some extent, but the probability cannot be avoided completely, and so the problem remains unsolved.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present inventions have been described in detail, it should be understood that the various changes, substitutions, and alterations could be made hereto without departing from the spirit and scope of the invention.

What is claimed is:

1. A wireless network controller comprising:
a plurality of base stations, having a plurality of wireless channels including wireless channels having different communication rates, for carrying out wireless communication with communication terminals using the wireless channels,
wherein the wireless network controller controls:
a base station communicating with the communication terminal before movement and
a movement destination base station for a new communication in the case that the communication terminal is required to communicate with another base station, wherein the wireless network controller further comprises:
a traffic amount confirmation section for confirming the traffic amount of the communication performed between the communication terminal and the base station that was used before movement and
a communication request section for obtaining the communication rate corresponding to the traffic amount confirmed using the traffic amount confirmation section and for requesting communication with the movement destination base station using a wireless channel having the communication rate.

2. The wireless network controller according to claim 1, wherein in the case that the confirmed traffic amount is more than the upper limit traffic amount of the communicating wireless channel, the communication request section requests the movement destination base station to perform communication using a wireless channel having a communication rate higher than the communication rate of the communicating wireless channel.

3. The wireless network controller according to claim 1, wherein in the case that the confirmed traffic amount is less than the lower limit traffic amount of the communicating wireless channel, the communication request section requests the movement destination base station to perform communication using a wireless channel having a communication rate lower than the communication rate of the communicating wireless channel.

4. The wireless network controller according to claim 1, wherein
a base station group has a plurality of the base stations controlled by the wireless network controller,
a wireless network has a plurality of the wireless network controllers and a plurality of the base station groups respectively controlled by the multiple wireless network controllers, and
in the case that a communication terminal communicating with a base station of a group controlled by one of the wireless network controllers has moved and is required to communicate with a base station of a group controlled using another wireless network controller, the communication request section requests the base station that is required for the communication to perform communication via the other wireless network controller.

5. A wireless communication system comprising:
a wireless network controller comprising:
multiple base stations, having a plurality of wireless channels including wireless channels having different communication rates, for carrying out wireless communication with communication terminals using the wireless channels,
wherein the wireless network controller controls:
a base station communicating with the communication terminal before movement and
a movement destination base station for a new communication in the case that said communication terminal is required to communicate with another base station, wherein the wireless network controller further comprises:
a traffic amount confirmation section for confirming the traffic amount of the communication performed between the communication terminal and the base station that was used before movement and
a communication request section for obtaining the communication rate corresponding to the traffic amount confirmed using the traffic amount confirmation section and for requesting communication with the movement destination base station using a wireless channel having the communication rate.
